(19) United States
(12) Patent Application Publication
(10) Pub. No.: US 2022/0073057 A1
(43) Pub. Date: Mar. 10, 2022

(54) PARKING ASSIST APPARATUS, PARKING ASSIST METHOD AND NON-TRANSITORY COMPUTER-READABLE MEDIUM

(71) Applicant: PANASONIC INTELLECTUAL PROPERTY MANAGEMENT CO., LTD., Osaka (JP)

(72) Inventors: Yukio SAKAI, Osaka (JP); Shota AKAURA, Kanagawa (JP); Yuya MATSUMOTO, Tokyo (JP)

(73) Assignee: PANASONIC INTELLECTUAL PROPERTY MANAGEMENT CO., LTD., Osaka (JP)

(21) Appl. No.: 17/528,791

(22) Filed: Nov. 17, 2021

Related U.S. Application Data
(63) Continuation of application No. PCT/JP2020/007267, filed on Feb. 21, 2020.

(30) Foreign Application Priority Data
Jun. 18, 2019 (JP) 2019-112949

(51) Int. Cl. B60W 30/06; G06K 9/00; B60W 50/14; G08G 1/14; B60L 53/37; B60L 53/36; B60L 53/126

(52) U.S. Cl. CPC B60W 30/06; G06K 9/00805; B60W 50/14; G08G 1/143; G08G 1/146; B60W 2050/146; B60L 53/37; B60L 53/36; B60L 53/126; B60W 2050/143; G08G 1/149

(57) ABSTRACT

A parking assist apparatus is configured to perform parking control so as to park a vehicle in a parking region provided with a wireless power transmitter configured to supply electric power, in a non-contact manner, to the vehicle capable of wireless charging. The parking assist apparatus includes: a processor; and a memory having instructions that, when executed by the processor, cause the parking assist apparatus to perform operations. The operations include: acquiring foreign object information indicating that a foreign object is present in a predetermined region including the wireless power transmitter in the parking region; and stopping the parking control in a case in which the foreign object information is acquired.

### CROSS-REFERENCE TO RELATED APPLICATIONS

This application is a continuation of PCT International Patent Application No. PCT/JP2020/007267 filed on Feb. 21, 2020, which claims the benefit of priority of Japanese Patent Application No. 2019-112949 filed on Jun. 18, 2019, the entire contents of which are incorporated herein by reference.

### FIELD

The present disclosure relates to a parking assist apparatus and a parking assist method that assist parking in a parking space provided with a power supply device.

### BACKGROUND

In the related art, a power supply device that enables a power supply of wireless charging to a vehicle has been developed. Japanese Patent No. 6350312 proposes a parking assist apparatus that guides a vehicle to a parking space by automatic driving control and parks the vehicle such that a position of a power reception coil of the vehicle matches a position of a power supply coil of a power supply unit.

### SUMMARY

The present disclosure provides a parking assist apparatus configured to perform parking control so as to park a vehicle in a parking region provided with a wireless power transmitter configured to supply electric power, in a non-contact manner, to the vehicle capable of wireless charging, the parking assist apparatus including: a processor; and a memory having instructions that, when executed by the processor, cause the parking assist apparatus to perform operations including: acquiring foreign object information indicating that a foreign object is present in a predetermined region including the wireless power transmitter in the parking region; and stopping the parking control in a case in which the foreign object information is acquired.

The present disclosure provides a parking assist method for performing parking control so as to park a vehicle in a parking region provided with a wireless power transmitter configured to supply electric power, in a non-contact manner, to the vehicle capable of wireless charging, the parking assist method including: acquiring foreign object information indicating that a foreign object is present in a predetermined region including the wireless power transmitter in the parking region; and stopping the parking control in a case in which the foreign object information is acquired.

The present disclosure provides a non-transitory computer-readable medium storing a program that, when executed by a processor, cause a computer to perform operations for performing parking control so as to park a vehicle in a parking region provided with a wireless power transmitter configured to supply electric power, in a non-contact manner, to the vehicle capable of wireless charging, the operations including: acquiring foreign object information indicating that a foreign object is present in a predetermined region including the wireless power transmitter in the parking region; and stopping the parking control in a case in which the foreign object information is acquired.

### BRIEF DESCRIPTION OF DRAWINGS

FIG. 1 is a block diagram showing an example of a configuration of a parking assist apparatus according to a first embodiment.

FIG. 2 is an illustrative diagram showing a vehicle including the parking assist apparatus according to the first embodiment and parking spaces of a parking lot where a wireless power supply to the vehicle can be performed.

FIG. 3 is a flowchart for illustrating an operation of the first embodiment.

FIG. 4 is a block diagram showing an example of a configuration of a power supply device according to a second embodiment.

FIG. 5 is an illustrative diagram showing a vehicle according to the second embodiment and parking spaces of a parking lot where a wireless power supply to the vehicle can be performed.

FIG. 6 is a flowchart for illustrating an operation of the second embodiment.

FIG. 7 is a block diagram showing an example of a configuration of a parking assist system according to a third embodiment.

FIG. 8 is a flowchart for illustrating an operation of the third embodiment.

FIG. 9 is a block diagram showing an example of a configuration of a parking assist apparatus according to a fourth embodiment.

FIG. 10 is a block diagram showing an example of a configuration of a power supply device according to a fifth embodiment.

FIG. 11 is a flowchart for illustrating an operation of a sixth embodiment.

### DETAILED DESCRIPTION

Hereinafter, embodiments in which a parking assist apparatus and a parking assist method according to the present disclosure are specifically disclosed will be described in detail with reference to the drawings as appropriate. However, unnecessarily detailed description may be omitted. For example, detailed description of well-known matters and redundant description of substantially the same configuration may be omitted. This is to avoid unnecessary redundancy of the following description and to facilitate understanding of those skilled in the art. It should be noted that the accompanying drawings and the following description are provided for a thorough understanding of the present disclosure by those skilled in the art, and are not intended to limit the subject matter recited in the claims.

(Findings Leading to Present Disclosure)

With development of automatic driving control, it is assumed that a vehicle supporting wireless charging is parked by the automatic driving control in a parking space in which a power supply device configured to perform a power supply of the wireless charging is installed.

However, a metal-containing foreign object or a foreign object such as an organism may be present in the parking space. If a metal-containing foreign object is present between a power supply coil of the power supply device and a power reception coil of the vehicle, fire or the like may occur during a power supply. Further, if an organism enters between the power supply coil of the power supply device and the power reception coil of the vehicle, the organism may be damaged during the power supply.

### First Embodiment

Therefore, in the present embodiment, by detecting a foreign object and controlling parking assist by automatic driving control in accordance with a detection result, it is possible to perform an automatic power supply while securing safety.

In the present embodiment, an example will be described in which, when a vehicle is parked by the automatic driving control in a parking region provided with a wireless power supply unit, a foreign object such as a metal-containing object is positioned in a predetermined region including the wireless power supply unit in the parking region, for example, on the power supply coil serving as the wireless power supply unit or in the vicinity thereof. Here, as an example of the parking assist apparatus and the parking assist method according to the present disclosure, an example in which the present disclosure is applied to parking assist in a parking lot having a plurality of parking spaces will be described, but the present disclosure may be applied to parking assist in various parking spaces provided with power supply devices.

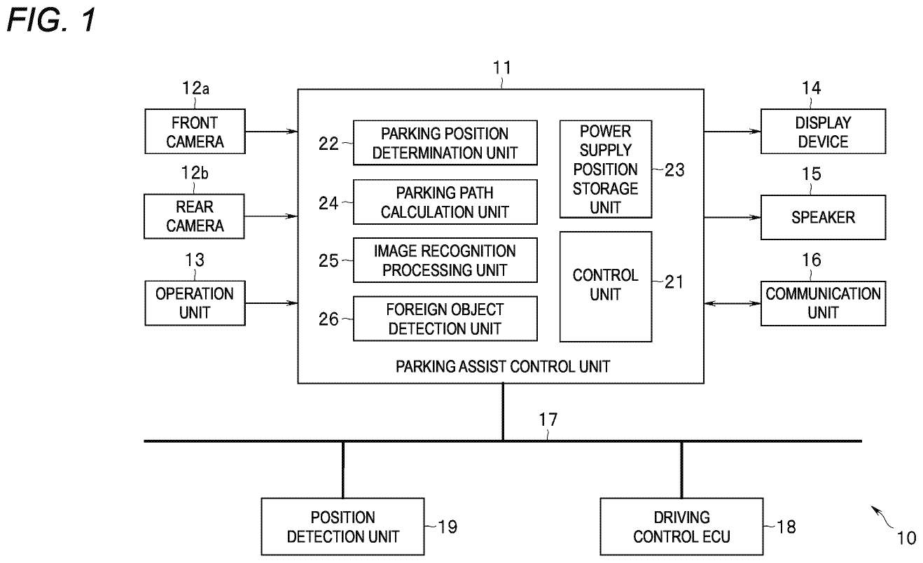

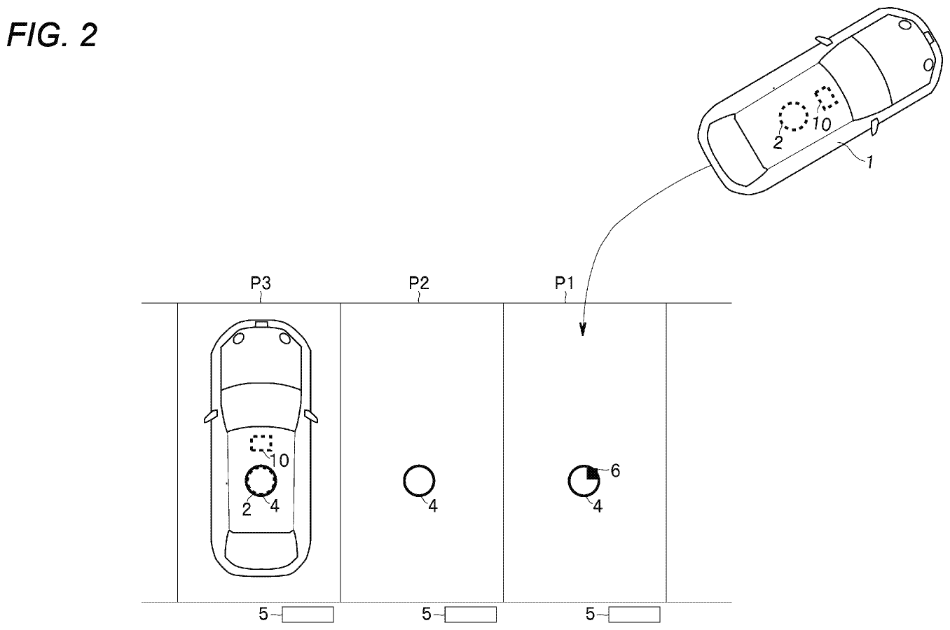

FIG. 1 is a block diagram showing an example of a configuration of a parking assist apparatus 10 according to a first embodiment. Further, FIG. 2 is an illustrative diagram showing a vehicle 1 including the parking assist apparatus 10 according to the first embodiment and parking spaces P1, P2, and so on (hereinafter, referred to as a parking space P when it is not necessary to distinguish these parking spaces) of a parking lot where a wireless power supply to the vehicle 1 can be performed.

In each parking space P serving as a parking region, a power supply coil 4 serving as an example of the wireless power supply unit that constitutes the power supply device is disposed. Further, a power supply control unit 5 that controls a supply of electric power to the power supply coil 4 is disposed in the vicinity of each parking space P.

The power supply coil 4 can transmit electric power in a non-contact manner. The power supply control unit 5 includes a controller, a communication device, and the like (not shown), and controls electric power transmission by the power supply coil 4. The power supply control unit 5 may have a function of transmitting position information of an arrangement position of the power supply coil 4 to the vehicle 1 by the communication device. When the vehicle 1 receives the position information of the power supply coil 4 from the power supply control unit 5, the vehicle 1 may be easily parked at a parking position (hereinafter, referred to as optimum charging position) where efficiency of wireless charging is higher.

In the vehicle 1, a power reception coil 2 is disposed in a lower portion of a vehicle body. That is, the vehicle 1 is an electric vehicle (EV), a plug-in hybrid vehicle (PHV), or the like that charges a battery (not shown) by an electric power supply from an outside.

The power reception coil 2 is disposed to face the power supply coil 4, so that electric power is transmitted from the power supply coil 4 in accordance with a principle of electromagnetic induction. Reception of electric power between the power reception coil 2 and the power supply coil 4 may be controlled by an electronic control unit (ECU) (not shown). When the power reception coil 2 receives an electric power supply, a battery (not shown) mounted on the vehicle 1 is charged.

In order to efficiently receive electric power from the power supply coil 4 in the power reception coil 2, it is necessary to control a position of the power reception coil 2 with respect to the power supply coil 4, that is, the parking position of the vehicle 1, with high accuracy so as to be positioned at the optimum charging position. Therefore, in the present embodiment, the vehicle 1 is provided with the parking assist apparatus 10.

In FIG. 1, the parking assist apparatus 10 mainly includes a parking assist control unit 11, a front camera 12a, a rear camera 12b, an operation unit 13, a display device 14, a speaker 15, a communication unit 16, a driving control ECU 18, and a position detection unit 19.

Each unit of the parking assist control unit 11 may be configured with a processor using a central processing unit (CPU), a field programmable gate array (FPGA), or the like, may operate in accordance with a program stored in a memory (not shown) to control each unit, or may implement some or all of functions by an electronic circuit of hardware.

The front camera 12a is a camera provided on a front side of the vehicle body of the vehicle 1. The rear camera 12b is a camera provided on a rear side of the vehicle body of the vehicle 1. The front camera 12a and the rear camera 12b, which are examples of a detection device, capture images of surroundings of the vehicle 1 on a front side and surroundings of the vehicle 1 on a rear side and output the captured images to the parking assist control unit 11. Although only the front camera 12a and the rear camera 12b are shown as the cameras in the example of FIG. 1, cameras that capture images of surroundings of the vehicle 1 on a right side and surroundings of the vehicle 1 on a left side may be added, and images captured by these cameras may also be given to the parking assist control unit 11.

In the rear camera 12b provided at a rear end of the vehicle 1, an optical axis (in a viewing direction) of an image-capturing lens faces relatively downward, and the rear camera 12b photographs a region including ground behind the vehicle at a predetermined viewing angle. When the vehicle 1 is parked backward in the parking space P, the rear camera 12b captures an image of the predetermined region including the wireless power supply unit in the parking region, specifically, a position of the power supply coil 4 and a vicinity thereof. It is preferable to adopt a lens having a relatively wide angle as the rear camera 12b.

The display device 14 is configured with, for example, a liquid crystal display, an organic electro-luminescence (EL) display, or the like, and is disposed in an instrument panel or the like. The display device 14 serving as an example of a notification unit is controlled by the parking assist control unit 11 to display an image or text. Further, the display device 14 can also display a menu display or the like on a display screen.

The operation unit 13 is configured with a switch, an operation knob, a keyboard, and the like (not shown), and receives a user operation by a user such as a driver. Further, a touch panel may be adopted as the operation unit 13. For example, a touch panel that constitutes the operation unit 13 may be disposed on a display screen of the display device 14.

The speaker 15 serving as a sound output device is controlled by the parking assist control unit 11 to output sound. The sound output device such as the speaker 15 also functions as an example of the notification unit. The communication unit 16 can communicate with an external device. The communication unit 16 may be, for example, a unit that can perform communication corresponding to a wireless standard such as a wireless local area network (LAN) or Bluetooth (registered trademark).

The driving control ECU 18 and the position detection unit 19 are connected to the parking assist control unit 11 via a predetermined bus 17 such as a controller area network (CAN) or a high-speed communication bus.

The driving control ECU 18 is an electronic control device that performs acceleration and deceleration control and steering control of the vehicle 1. For example, the driving control ECU 18 is a device that controls an accelerator, a brake, a steering wheel, and the like of the vehicle 1. Under control of the driving control ECU 18, the vehicle 1 related to automatic parking is moved.

The position detection unit 19 is configured with a gyro sensor, an acceleration sensor, a positioning sensor, a geomagnetic sensor, an orientation sensor, a steering angle sensor, a vehicle speed sensor, and the like (not shown), and detects a position of the vehicle 1 and outputs a detection result to the driving control ECU 18 and the parking assist control unit 11. For example, the position detection unit 19 may calculate a movement amount of the vehicle 1 by various sensors, and may obtain a position of the own vehicle by using a positioning result of the positioning sensor such as a global positioning system (GPS) (registered trademark) or a high-precision positioning system. The position detection unit 19 may be configured to detect not only a position of the vehicle 1 but also a direction of the vehicle 1.

The parking assist control unit 11 includes a control unit 21, a parking position determination unit 22, a power supply position storage unit 23, a parking path calculation unit 24, an image recognition processing unit 25, and a foreign object detection unit 26. The control unit 21 controls the units of the parking assist control unit 11 and achieves automatic parking control in cooperation with the driving control ECU 18. The automatic parking control in the present disclosure includes parking control related to parking assist. For example, a steering operation includes parking control in which a control system of the vehicle including the parking assist control unit 11 automatically performs control, and a driver executes semi-automatic parking assist in which a part of automatic control is performed, such as operating only the accelerator and the brake in accordance with an instruction from the control system.

The parking position determination unit 22 determines a target parking position of the vehicle 1 (hereinafter, referred to as target parking position). For example, the parking position determination unit 22 determines the target parking position based on a user operation on the operation unit 13. For example, the parking position determination unit 22 may determine the target parking position by performing an operation for parking in a state where the user stops the vehicle in front of the parking space P desired to be parked.

The target parking position will finally become the optimum charging position, but the optimum charging position is not necessarily designated as the target parking position from beginning.

The power supply position storage unit 23 stores position information of each power supply coil of each parking space P (hereinafter, referred to as power supply unit position information). For example, the control unit 21 may acquire the power supply unit position information and store the acquired power supply unit position information in the power supply position storage unit 23 by accessing an external server via the communication unit 16.

When the power supply position storage unit 23 that stores power supply position information of the parking space P to be parked is present in the parking assist control unit 11, the parking position determination unit 22 may determine the target parking position based on information read from the power supply position storage unit 23 by an operation of designating the parking space P to be parked by the user. For example, when a parking space ID is assigned to each parking space P, the target parking position may be determined by designating the ID. Further, in this case, the optimum charging position may be determined as the target parking position.

The parking path calculation unit 24 calculates a path (parking path) for moving the vehicle 1 to a parking position in accordance with a deviation between an own vehicle position and a direction detected by the position detection unit 19 and the target parking position, and outputs a calculation result to the driving control ECU 18. Accordingly, the driving control ECU 18 performs the automatic parking control.

The image recognition processing unit 25 inputs information of images in a vicinity of the vehicle captured by the cameras 12a and 12b, performs image analysis on the input captured images, and gives an analysis result to the parking path calculation unit 24. The parking path calculation unit 24 may perform correction of bringing the target parking position close to the optimum charging position and correction of the parking path by using the image analysis result from the image recognition processing unit 25. For example, the parking path calculation unit 24 can correct the target parking position and the parking path based on an image recognition result of a line indicating a partition of the parking space P, an image recognition result of a power supply unit including the power supply coil 4, and the like.

During the automatic parking control, the driving control ECU 18 calculates a speed and a steering angle of the vehicle 1 and controls the accelerator, the brake, the steering wheel, and the like of the vehicle 1, based on information of the parking path. The parking path calculation unit 24 outputs parking path information to the driving control ECU 18 in accordance with a deviation between the own vehicle position and the direction that change as the vehicle 1 moves and the target parking position, and the driving control ECU 18 controls the accelerator, the brake, the steering wheel, and the like of the vehicle 1 based on the parking path information, so that the automatic parking control for finally moving the vehicle 1 to the target parking position is performed.

The image recognition processing unit 25 performs image recognition of an object by using image information (detection information) in a vicinity of the vehicle from the cameras 12a and 12b, and gives an image recognition result to the foreign object detection unit 26. The foreign object detection unit 26 functions as a foreign object information acquisition unit, and acquires foreign object information indicating presence of a foreign object as a detection result. The foreign object detection unit 26 detects whether a foreign object such as a metal-containing object is present in the predetermined region (on the power supply coil 4 and in the vicinity thereof) including the wireless power supply unit in the parking region in accordance with the image recognition result of the image recognition processing unit 25. The foreign object detection unit 26 may determine whether a recognized object is a metal-containing foreign object based on a shape, a color, and the like of the foreign object based on the image recognition result of the image recognition processing unit 25, or may estimate that an object larger than a predetermined size is the metal-containing foreign object.

The foreign object detection unit 26 may include a detection device such as a metal detector or a magnetic field sensor, and may be capable of detecting whether the foreign object such as the metal-containing object is present in the predetermined region including the wireless power supply unit in the parking region. For example, such a metal detector or the like may be disposed at a lower portion of a front end or a rear end of the vehicle 1, or may be disposed in the vicinity of the power reception coil 2. Further, the communication unit 16 can also receive and acquire information of the foreign object detected by the detection device such as the metal detector or the magnetic field sensor provided outside the vehicle.

The control unit 21 acquires the foreign object information by the foreign object detection unit 26, and stops the automatic parking control when it is determined that the foreign object such as the metal-containing object is present in the predetermined region including the wireless power supply unit in the parking region. Further, the control unit 21 causes the display device 14 to display a message indicating presence of the foreign object, and notifies the user in the vehicle of the message. Further, in this case, a display that prompts the user to designate another parking space P may be performed. Further, when the parking space P is provided in a parking lot managed by an administrator, the control unit 21 may be configured to notify the administrator that the metal-containing foreign object is present in the parking space P by the communication unit 16. Further, when the foreign object information is acquired, the control unit 21 may transmit an instruction to the power supply coil 4 to stop charging of the wireless charging.

An example has been described in which the metal-containing foreign object is detected by the image analysis based on an image captured by the rear camera 12b or the like, but the metal-containing foreign object may be detected using a sonar, a radar, light detection and ranging (LIDAR), or the like without being limited to a camera.

In each parking space P, a lighting device such as a lamp as an example of the notification unit indicating a state of the parking space P may be installed. Lighting of the lamp may be controlled by, for example, a management device or the like of the parking lot. For example, the lamp may be configured to light in different lighting colors depending on a state, such as blue when the parking space P is available, red when the vehicle is stopped, and orange when the wireless charging cannot be performed due to a foreign object. A lighting method including the lighting color can be set as appropriate. Further, a lighting mode such as the number of times of blinking of the lamp, a cycle of the blinking of the lamp, a lighting time, a lighting pattern, and the like may be different depending on a state.

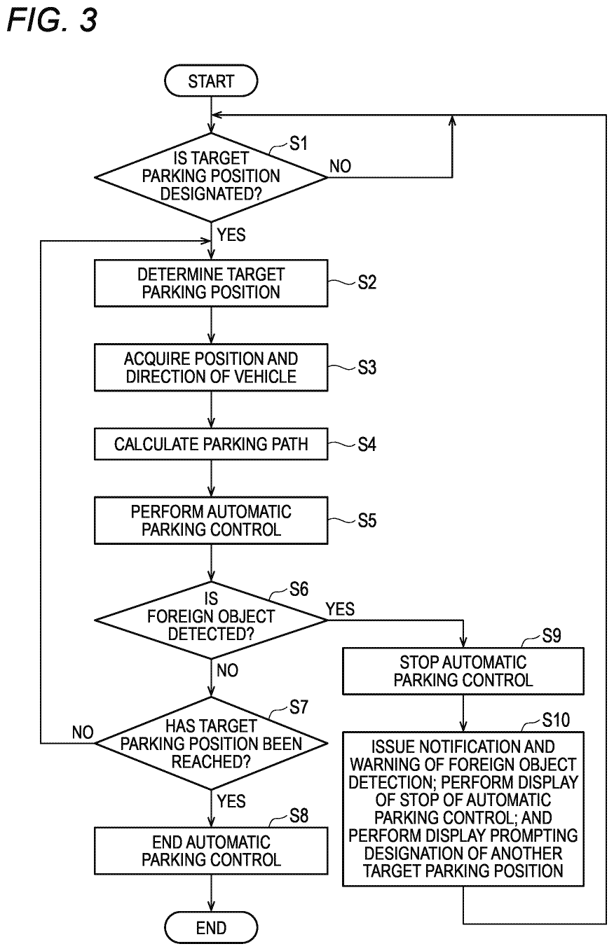

Next, an operation of the parking assist apparatus of the present embodiment will be described. FIG. 3 is a flowchart for illustrating the operation of the first embodiment.

Now, as shown in FIG. 2, it is assumed that a vehicle has already been parked in a parking space P3 among three parking spaces P1 to P3, and the user stops the vehicle 1 in the available parking space P1 to perform the wireless charging. In this case, the user designates the target parking position by the operation unit 13. For example, when registration of the parking space P1 is present in the power supply position storage unit 23, the user can designate the target parking position by designating an ID of the parking space P1 or the like. Further, when the registration of the parking space P1 is not present in the power supply position storage unit 23, the user can designate the target parking position by temporarily stopping the vehicle 1 in front of the parking space P1 and designating the automatic parking control.

In step S1 of FIG. 3, the control unit 21 is in a standby state for designating the target parking position. When a target parking position is designated by the user, the control unit 21 receives an operation input of the user, and the parking position determination unit 22 determines the target parking position (step S2).

The position detection unit 19 detects a position and a direction of the vehicle 1, and supplies a detection result to the parking assist control unit 11. The parking path calculation unit 24 acquires the position and the direction of the vehicle 1 (step S3), and calculates a parking path based on a deviation between the acquired position and direction and the target parking position (step S4). For example, when the vehicle 1 is positioned at a position of FIG. 2, the parking path calculation unit 24 obtains a parking path indicated by a curved arrow.

At a stage of designating the target parking position, for example, when the vehicle 1 is in front of the parking space P1 and an advancing direction is oriented in a direction substantially perpendicular to a parking direction, the parking path calculation unit 24 may calculate a parking path that causes the vehicle 1 to temporarily advance to position the vehicle 1 at a position of FIG. 2 and then moves the vehicle 1 backward to a parking space P1 side.

The parking path calculation unit 24 outputs information of the calculated parking path to the driving control ECU 18. The driving control ECU 18 determines a steering angle, a moving speed, and the like based on the received information of the parking path, and performs the automatic parking control of the vehicle 1 (step S5). In this way, in a case of FIG. 2, the vehicle 1 moves backward along the parking path indicated by an arrow.

In the present embodiment, after a start of a period of the automatic parking control, that is, after the target parking position is designated, the foreign object detection unit 26 detects whether the metal-containing foreign object is positioned on the power supply coil 4 or in the vicinity thereof. In step S6, the control unit 21 determines whether the metal-containing foreign object is detected by the foreign object detection unit 26.

When the metal-containing foreign object is not present on the power supply coil 4 or in the vicinity thereof, the control unit 21 shifts the processing from step S6 to step S7, and determines whether the vehicle 1 has reached the target parking position based on a detection result of the position detection unit 19. When the vehicle 1 has not reached the target parking position, the control unit 21 returns the processing from step S7 to step S2 and repeats the processings of steps S2 to S7.

When the target parking position designated by the user is the optimum charging position, the parking position determination unit 22 does not change the target parking position. When the target parking position designated by the user is not the optimum charging position, the parking position determination unit 22 changes the target parking position to the optimum charging position where the power reception coil 2 of the own vehicle and the power supply coil 4 face each other. For example, the parking position determination unit 22 grasps a position of the power supply unit where the power supply coil 4 is positioned based on an image analysis result of the image recognition processing unit 25 for a captured image of the rear camera 12b, and corrects the target parking position so as to coincide with the optimum charging position.

In this way, finally, the target parking position coincides with the optimum charging position, and the vehicle 1 reaches the optimum charging position. When the vehicle 1 reaches the optimum charging position that is the target parking position, the control unit 21 ends the automatic parking control (step S8). In a state where the vehicle 1 is positioned at the optimum charging position, power is supplied from the power supply coil 4 to the power reception coil 2, and a battery (not shown) is charged.

Now, it is assumed that a metal-containing foreign object 6 shown in FIG. 2 is present in a predetermined region in the vicinity of the power supply coil 4. When the vehicle 1 reaches a predetermined position, the foreign object detection unit 26 detects that the metal-containing foreign object 6 is present at the position of the power supply coil 4 by an image recognition processing of the image recognition processing unit 25 on sequentially input captured images from the rear camera 12b.

At a stage where the power supply coil 4 enters a visual field range of the rear camera 12b, the rear camera 12b can reliably capture an image of the power supply coil 4, and the foreign object detection unit 26 can reliably detect the metal-containing foreign object before the vehicle 1 reaches the target parking position. Further, even when a metal detector or the like is installed at a lower portion of a rear end of the vehicle 1, it is possible to reliably detect the metal-containing foreign object before the vehicle 1 reaches the target parking position.

When acquiring the foreign object information based on a detection result of the foreign object detection unit 26, the control unit 21 shifts the processing from step S6 to step S9 and stops the automatic parking control. Then, the control unit 21 causes the display device 14 to display a warning display indicating that the metal-containing foreign object 6 is present on the power supply coil 4 or in the vicinity thereof, and notifies the user of the warning display. Further, the control unit 21 causes the display device 14 to display a state display indicating that the automatic parking control has been stopped, and notifies the user of the state display. The display device 14 may display various pieces of information such as a state of the parking space, and a factor when parking is impossible or charging is impossible. Further, the control unit 21 causes the display device 14 to display a guide display that prompts designation of another target parking position (step S10). Further, the control unit 21 may cause the speaker 15 to output a sound for notifying a detection result of the foreign object, a state of the automatic parking control, and the like to notify the user. Furthermore, a notification indicating that the metal-containing foreign object 6 has been detected may be sent to the management device or the like via the communication unit 16.

Accordingly, the user can recognize that the foreign object is present at a current target parking position and the wireless charging cannot be performed, and it is better to move the own vehicle to another parking space P. When another parking space is designated as the target parking position by the user, steps S2 to S7 are executed, and the vehicle 1 is parked in another parking space. Even when various notifications during foreign object detection are performed, when the user or the administrator removes the foreign object and re-designates the parking space P1 as the target parking position, steps S2 to S7 are executed thereafter, and the vehicle 1 is stopped at an optimum charging position of the parking space P1.

The management device notified of the detection of the foreign object may change a lighting color of the lamp indicating a state of the parking space P. Further, the lighting color of the lamp may be changed by an operation of the administrator. Accordingly, the user who wants to use the parking space P can easily know the parking space P in a state where the wireless charging cannot be performed due to the foreign object by the lighting color of the lamp.

In the above-described embodiment, an example has been shown in which the vehicle 1 includes the parking assist apparatus 10 including the parking assist control unit 11, but the parking assist control unit may be provided in another apparatus. For example, a parking assist control unit may be provided in another apparatus such as a power supply device provided in a parking space, a management server of the parking lot, or another control device, and an instruction may be transmitted from an external parking assist control unit to the parking assist control unit 11 or the driving control ECU 18 of the vehicle 1 to perform stop control of the automatic parking control or the like.

As described above, in the present embodiment, when the vehicle is parked in the parking space where the wireless charging can be performed by the automatic driving control, it is detected whether the foreign object such as the metal-containing object is present in the predetermined region including the wireless power supply unit in the parking region. Then, the parking assist by the automatic driving control is controlled in accordance with a detection result of the foreign object. Accordingly, it is possible to execute an automatic power supply of the wireless charging and the parking assist while securing safety.

### Second Embodiment

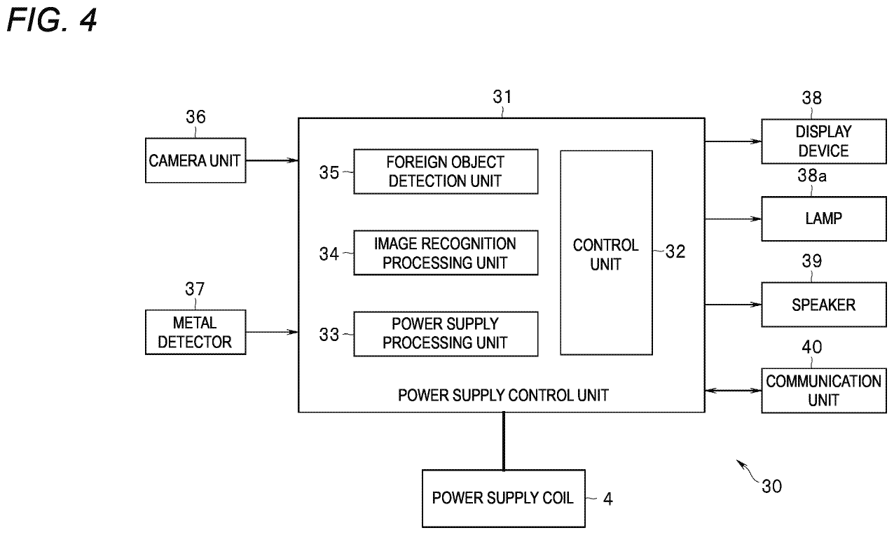

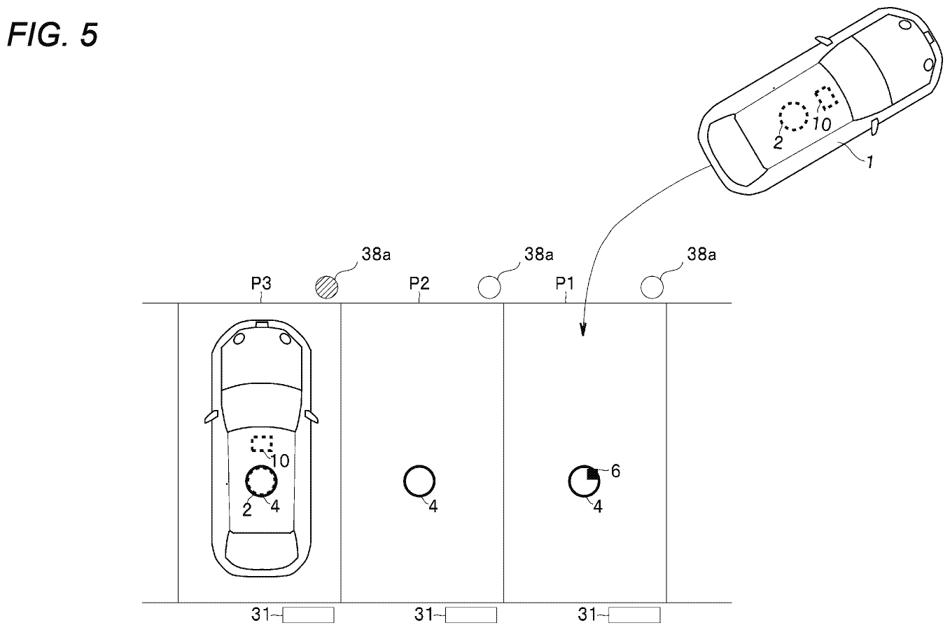

FIG. 4 is a block diagram showing an example of a configuration of a power supply device 30 according to a second embodiment. Further, FIG. 5 is an illustrative diagram showing the vehicle 1 according to the second embodiment and the parking spaces P of a parking lot where a wireless power supply to the vehicle 1 can be performed. In FIGS. 4 and 5, the same components as those of FIG. 2 are denoted by the same reference numerals, and the description thereof will be omitted.

The second embodiment is different from the first embodiment in that a power supply device detects a metal-containing foreign object. That is, in the second embodiment, information of the foreign object detected by the power supply device is acquired by the communication unit 16 of the vehicle 1. In this case, the communication unit 16 of the vehicle 1 functions as a foreign object information acquisition unit. The power supply device may execute some functions of the parking assist apparatus, and the power supply device may perform stop control of automatic parking control or the like on the vehicle 1. Further, as the vehicle 1, the foreign object detection unit 26 may be omitted from the parking assist control unit 11.

In the second embodiment, as shown in FIG. 5, a power supply control unit 31 instead of the power supply control unit 5 of FIG. 2 is installed in each parking space P. FIG. 4 shows an example of a configuration of the power supply device 30 including the power supply control unit 31.

In FIG. 4, the power supply device 30 is disposed corresponding to each parking space P, and mainly includes the power supply coil 4, the power supply control unit 31, a metal detector 37, a display device 38, and a communication unit 40. The power supply device 30 may include a camera unit 36 and a speaker 39. The power supply control unit 31 includes a control unit 32, a power supply processing unit 33, and a foreign object detection unit 35. The power supply control unit 31 may include an image recognition processing unit 34.

Each unit of the power supply control unit 31 may be configured with a processor using a CPU, an FPGA, or the like, may operate in accordance with a program stored in a memory (not shown) to control each unit, or may implement some or all of functions by an electronic circuit of hardware.

The metal detector 37 is disposed, for example, in the vicinity of the power supply coil 4, and detects a metal-containing foreign object present in a predetermined region including a wireless power supply unit in a parking region, specifically, on the power supply coil 4 and in the vicinity thereof. Instead of the metal detector 37, a magnetic field sensor that detects the metal-containing foreign object present on the power supply coil 4 and in the vicinity thereof may be used. The metal detector 37 outputs a detection result of the metal-containing foreign object to the power supply control unit 31.

In the power supply control unit 31, the foreign object detection unit 35 inputs the detection result of the metal detector 37, and detects whether the metal-containing foreign object is present in the predetermined region including the wireless power supply unit in the parking region, specifically, on the power supply coil 4 and in the vicinity thereof, based on the detection information of the metal detector 37. The power supply control unit 31 transmits the information of the foreign object detected by the foreign object detection unit 35 to the vehicle 1 via the communication unit 40. When acquiring the foreign object information, the vehicle 1 stops the automatic parking control as shown in the first embodiment. When the power supply control unit 31 acquires the foreign object information, an instruction may be transmitted from the power supply device 30 to the vehicle 1 to stop the automatic parking control.

A housing that houses the power supply control unit 31 is disposed in the vicinity of each parking space P, for example, as shown in FIG. 5. The camera unit 36 is, for example, a camera that is attached to the housing that houses the power supply control unit 31 and that can capture an image in the predetermined region including the wireless power supply unit in the parking region, specifically, the power supply coil 4 and a region in the vicinity thereof as a visual field range. The camera unit 36 captures an image of the power supply coil 4 and surroundings thereof and outputs the captured image to the power supply control unit 31.

The display device 38 is configured with, for example, a liquid crystal display, an organic EL display, or the like, and is disposed on a front surface of the housing that houses the power supply control unit 31. The display device 38 may be disposed at a position that does not interfere with entry into each parking space P on an entrance side. The display device 38 is controlled by the power supply control unit 31 to display an image or text. Further, the display device 38 can also display a menu display or the like on a display screen.

A lighting device using a lamp 38a serving as an example of a notification unit indicates a state of the parking space P. In an example of FIG. 5, the lamp 38a is installed at an entrance of the parking space P. The lamp 38a may be appropriately provided at any position such as above the parking space P, on ground, an end portion on a far side, and the power supply control unit 31. The control unit 32 may be configured to control the lamp 38a to indicate a state of the parking space P by, for example, different lighting colors. For example, the control unit 32 may light the lamp 38a in different lighting colors depending on a state, such as blue when the parking space P is available, red when the vehicle is stopped (oblique lines in FIG. 5), and orange when the wireless charging cannot be performed due to a foreign object. Further, a lighting mode such as the number of times of blinking of the lamp, a cycle of the blinking of the lamp, a lighting time, a lighting pattern, and the like may be different depending on a state. A lighting method of the lighting device including the lighting color and the lighting mode can be set as appropriate.

The speaker 39 is controlled by the power supply control unit 31 to output a sound. The communication unit 40 can communicate with an external device. The communication unit 40 maybe, for example, a unit that can perform communication corresponding to a wireless standard such as a wireless LAN or Bluetooth (registered trademark).

In the power supply control unit 31, the control unit 32 controls the units of the power supply control unit 31. The power supply processing unit 33 executes a power supply processing from the power supply coil 4 to the power reception coil 2 by disposing the power reception coil 2 of the vehicle 1 to face the power supply coil 4.

The image recognition processing unit 34 inputs a captured image from the camera unit 36, performs image analysis on the captured image, and gives an analysis result to the foreign object detection unit 35. The foreign object detection unit 35 may detect whether the metal-containing foreign object is present in the predetermined region including the wireless power supply unit in the parking region in accordance with the image recognition result of the image recognition processing unit 34.

In an example of FIG. 4, an example has been described in which the foreign object detection unit 35 detects the foreign object such as the metal-containing object by using the detection result of the metal detector 37 and based on the image analysis result of the captured image by the camera unit 36, but the present disclosure is not limited thereto. The foreign object detection unit 35 may detect the metal-containing foreign object by only one of the metal detector 37 and the camera unit 36, and in this case, the other may be omitted. Further, the metal-containing foreign object may be detected using the magnetic field sensor.

The control unit 32 has a function serving as a power supply instruction unit. When the foreign object information is acquired by the foreign object detection unit 35, the control unit 32 controls the power supply processing unit 33 to stop a power supply and does not perform the power supply. Further, the control unit 32 causes the display device 38 or the lamp 38a to execute a warning display indicating that the wireless charging cannot be performed due to current presence of a foreign object. Further, the control unit 32 may be configured to notify the management device or the like that the metal-containing foreign object is present in the parking space P via the communication unit 40. Further, the control unit 32 may notify the nearby vehicle 1 of a message indicating that the wireless charging cannot be performed in the parking space P via the communication unit 40. The control unit 32 may cause the speaker 39 to generate various warning sounds. For example, when the vehicle wants to enter a parking space in a state where the wireless charging cannot be performed, an alarm may be generated from the speaker.

Also in the present embodiment, an example has been described in which the metal-containing foreign object is detected by the image analysis using an image captured by the camera unit 12, but the present disclosure is not limited to a camera, and the metal-containing foreign object may be detected using a sonar, a radar, light detection and ranging (LIDAR), or the like.

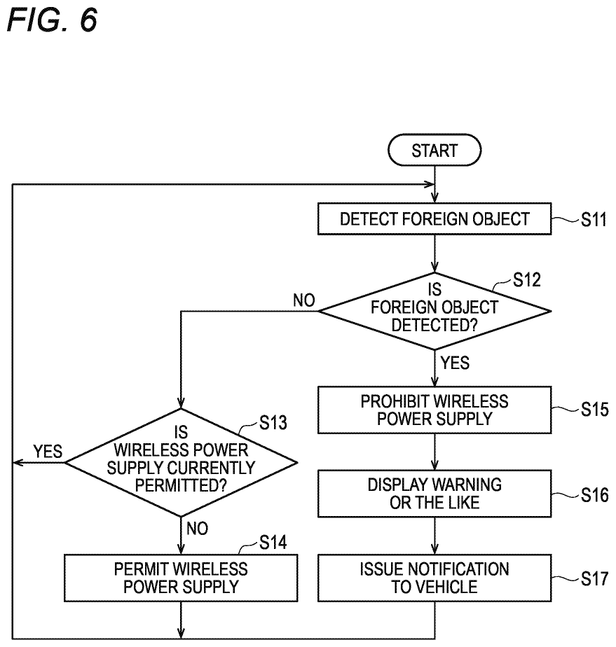

Next, an operation of the parking assist apparatus of the present embodiment will be described. FIG. 6 is a flowchart for illustrating the operation of the second embodiment.

When the power supply device 30 is powered on, the control unit 32 of the power supply control unit 31 detects the metal-containing foreign object in step S11 of FIG. 6. That is, a detection result of the metal detector 37 and a captured image of the camera unit 36 are sequentially input to the power supply control unit 31. The image recognition processing unit 34 detects the metal-containing foreign object by the image analysis on the captured image of the camera unit 36. The foreign object detection unit 35 determines whether the metal-containing foreign object is present on the power supply coil 4 and in the vicinity thereof based on the detection result of the metal detector 37 or the detection result of the image recognition processing unit 34.

In step S12, the control unit 32 determines whether the metal-containing foreign object is detected by the foreign object detection unit 35. When the metal-containing foreign object is not present on the power supply coil 4 or in the vicinity thereof, the control unit 21 shifts the processing from step S12 to step S13, and determines whether a power supply of the wireless charging is currently permitted. Normally, when the metal-containing foreign object is not present on the power supply coil 4 and in the vicinity thereof, the power supply of the wireless charging is permitted, and the control unit 21 returns the processing from step S13 to step S11 and repeats the detection processing of the foreign object.

Now, it is assumed that the metal-containing foreign object 6 shown in FIG. 5 is present on the power supply coil 4. In this case, the foreign object 6 is detected by the foreign object detection unit 35, and the control unit 32 shifts the processing from step S12 to step S15 to prohibit the power supply of the wireless charging. Accordingly, the power supply processing unit 33 does not supply power for the wireless charging. For example, even when the power reception coil 2 of the vehicle 1 is disposed to face the power supply coil 4, the power supply processing unit 33 does not execute the power supply of the wireless charging. Accordingly, fire or the like of the foreign object 6 is reliably prevented.

The control unit 32 causes the display device 38 to display a warning display indicating that the metal-containing foreign object 6 is present in the predetermined region including the wireless power supply unit (step S16). Further, in order to indicate that the wireless charging cannot be performed due to the foreign object, the control unit 32 changes a lighting color of the lamp 38a to, for example, orange, and issues a warning. With these warnings, the user of the vehicle 1 can recognize in advance that the wireless charging is prohibited due to the foreign object 6 before parking in the parking space P.

The control unit 32 transmits the information of the foreign object detected by the foreign object detection unit 35 to the vehicle 1 via the communication unit 40 and notifies the vehicle 1 of the foreign object information (step S17). When acquiring the foreign object information, the vehicle 1 stops the automatic parking control as shown in the first embodiment. Further, the control unit 32 may notify another management device that the metal-containing foreign object 6 is detected. The control unit 32 may notify, via the communication unit 40, a nearby vehicle that the wireless charging cannot be performed.

After the processing of step S17, the control unit 32 returns the processing to step S11, and repeats the detection processing of the foreign object at predetermined time intervals. After the foreign object is detected, for example, when the foreign object 6 is removed by the administrator or the like, the processing is shifted from step S12 to step S13. In this case, the power supply of the wireless charging cannot be performed. The control unit 32 switches the power supply of the wireless charging to a permitted state to restart the power supply in next step S14, and returns the processing to step S11.

As described above, in the present embodiment, when the vehicle is parked in the parking space where the wireless charging can be performed by the automatic driving control, the power supply device detects whether the metal-containing foreign object is present in the predetermined region including the wireless power supply unit in the parking region. Then, permission or prohibition of the power supply of the wireless charging is controlled in accordance with a detection result of the foreign object. Further, the power supply device transmits the foreign object information to the vehicle to stop the automatic parking control. Further, the power supply device transmits the foreign object information to the vehicle and stops the automatic parking control. Further, the power supply device presents to the user whether the wireless charging can be performed. Accordingly, it is possible to execute the wireless charging automatic power supply and the parking assist while securing safety. In the present embodiment, in a case where the foreign object is present, when the user designates the target parking position, it is possible to recognize in advance whether the wireless charging can be performed. Further, when the foreign object detection is performed on a power supply side, it is also possible to detect that the foreign object is removed and notify the vehicle or the like of the removal.

In the second embodiment, an example has been described in which the foreign object detection function is incorporated in the power supply device, but a device having the foreign object detection function may be provided in each parking space.

### Third Embodiment

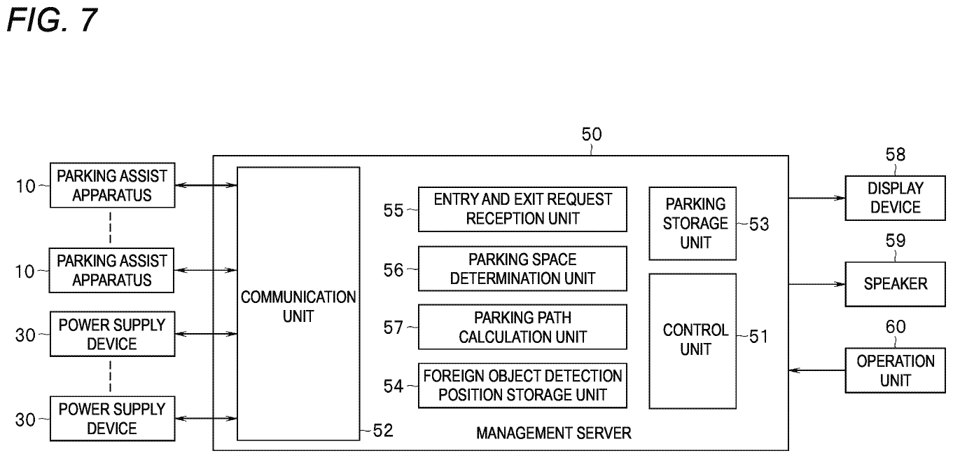

FIG. 7 is a block diagram showing an example of a configuration of a parking assist system according to a third embodiment. In FIG. 7, the same components as those of

FIGS. 1 and 4 are denoted by the same reference numerals, and the description thereof will be omitted.

The third embodiment shows an example in which the parking assist system is applied to auto valet parking in which a management server 50 serving as an example of a management device is provided and a parking lot having the parking space P shown in FIG. 5 is managed by the management server 50. The auto valet parking is a system that automatically parks a vehicle by applying parking assist by automatic driving control to a so-called valet parking type parking lot where a vehicle is kept and parked on a management side at a request of a vehicle user. The third embodiment can be applied not only to the second embodiment but also to the first embodiment.

In the third embodiment, description will be made assuming that the vehicle 1 on which the parking assist apparatus 10 of FIG. 1 is mounted is parked in a parking lot where the power supply device 30 including the power supply control unit 31 of FIG. 4 is installed in each parking space P. In the example of FIG. 6, an example is shown in which the management server 50 performs automatic parking control by communicating with the parking assist apparatus 10 having foreign object detection function and the power supply device 30 having the foreign object detection function, but any one of a vehicle side and a power supply device side may have the foreign object detection function.

The management server 50 serving as an example of the management device manages a parking lot having the parking space P similar to that of FIG. 5. The management server 50 mainly includes a control unit 51, a communication unit 52, a parking storage unit 53, a foreign object detection position storage unit 54, an entry and exit request reception unit 55, a parking space determination unit 56, a parking path calculation unit 57, a display device 58, a speaker 59, and an operation unit 60.

The control unit 51, the entry and exit request reception unit 55, the parking space determination unit 56, and the parking path calculation unit 57 of the management server 50 may be configured with processors each using a CPU, an FPGA, or the like, may operate in accordance with a program stored in a memory (not shown) to control each unit, or may implement some or all of functions by an electronic circuit of hardware.

The communication unit 52 can communicate with an external device. The communication unit 52 may be, for example, a unit that can perform communication corresponding to a wireless standard such as a wireless LAN or Bluetooth (registered trademark). The communication unit 52 can communicate with the communication unit 16 of the parking assist apparatus 10, and can communicate with the communication unit 40 of the power supply device 30.

The parking storage unit 53 is controlled by the control unit 51 to store information of vehicles parked in all parking spaces P in the parking lot. Further, the foreign object detection position storage unit 54 is given a detection result of a metal-containing foreign object from the parking assist apparatus 10 or the power supply device 30, and stores information of a parking space P where the metal-containing foreign object is present.

In the present embodiment, the control unit 51 sequentially receives the information of the detection result of the metal-containing foreign object from the parking assist apparatus 10 or the power supply device 30 via the communication unit 52. When the metal-containing foreign object is detected, the control unit 51 updates, in the foreign object detection position storage unit 54, information of the parking space P where the metal-containing foreign object is present.

When receiving an entry and exit request from the vehicle 1, the communication unit 52 gives the request to the entry and exit request reception unit 55. The entry and exit request reception unit 55 gives an entry request to the parking space determination unit 56, and updates information in the parking storage unit 53 based on an exit request.

The parking space determination unit 56 determines the target parking position from the available parking spaces P based on information of the parking storage unit 53 and the foreign object detection position storage unit 54 in response to the entry request, and outputs a determination result to the parking path calculation unit 57. The parking space determination unit 56 updates the information in the parking storage unit 53 based on the determined target parking position. In this way, the parking storage unit 53 stores each parking space P and information for identifying the vehicle 1 parked in each parking space P in association with each other.

The parking path calculation unit 57 acquires position information of the vehicle 1 that has issued an entry request via the communication unit 52, and calculates a parking path based on a positional relationship with the target parking position. The parking path calculated by the parking path calculation unit 57 is transmitted to the parking assist apparatus 10 via the communication unit 52. Thereafter, communication between the parking assist apparatus 10 and the parking path calculation unit 57 is sequentially performed, the vehicle 1 acquires parking space information and parking path information of the target parking position, and the automatic parking control is executed toward the target parking position.

Before the vehicle 1 reaches the target parking position, a metal-containing foreign object may be detected by the parking assist apparatus 10 or the power supply device 30 in a predetermined region of the target parking position, for example, on the power supply coil 4 or in the vicinity thereof. In this case, the detected information on foreign object detection is transmitted from the communication unit 16 of the parking assist apparatus 10 or the communication unit 40 of the power supply device 30, and is received by the communication unit 52 of the management server 50. When receiving information on the foreign object via the communication unit 52, the control unit 51 controls the foreign object detection position storage unit 54 to update the information of the parking space P. For example, a parking space where the metal-containing foreign object is present is excluded from a parking target.

In this case, the control unit 51 determines whether the automatic parking control is performed on the parking space P where the metal-containing foreign object is present. When the automatic parking control is performed, the control unit 51 controls the parking path calculation unit 57 to stop the automatic parking control. Further, the control unit 51 controls the parking space determination unit 56 to determine a new target parking position and designate another parking space. Then, the control unit 51 controls the parking path calculation unit 57 so as to restart the automatic parking control for the new target parking position. Further, the parking storage unit 53 is also updated.

The display device 58 is configured with, for example, a liquid crystal display, an organic EL display, or the like, and is controlled by the control unit 51 to display an image or text. Further, the display device 58 can also display a menu display or the like on a display screen.

The speaker 59 is controlled by the control unit 51 to output a sound. The operation unit 60 is configured with a keyboard, a switch, and the like (not shown) and receives a user operation. Further, a touch panel may be adopted as the operation unit 60. For example, a touch panel that constitutes the operation unit 60 may be disposed on the display screen of the display device 58.

The control unit 51 may transmit warning information indicating that the metal-containing foreign object is detected to the parking assist apparatus 10 and the power supply device 30 via the communication unit 52 to notify the parking assist apparatus 10 and the power supply device 30, and cause the display device 14, the display device 38, and the lamp 38a to execute the warning. Further, when receiving the information indicating that the metal-containing foreign object is detected, the control unit 51 may cause the display device 58 to display a warning indicating that the metal-containing foreign object is detected.

For example, it is possible to notify the vehicle 1 that does not have the foreign object detection function that the target parking space is changed due to presence of the foreign object. Alternatively, it is possible to display a warning that the wireless charging cannot be performed due to presence of the foreign object to the power supply control unit 5 of FIG. 2 which does not have the foreign object detection function.

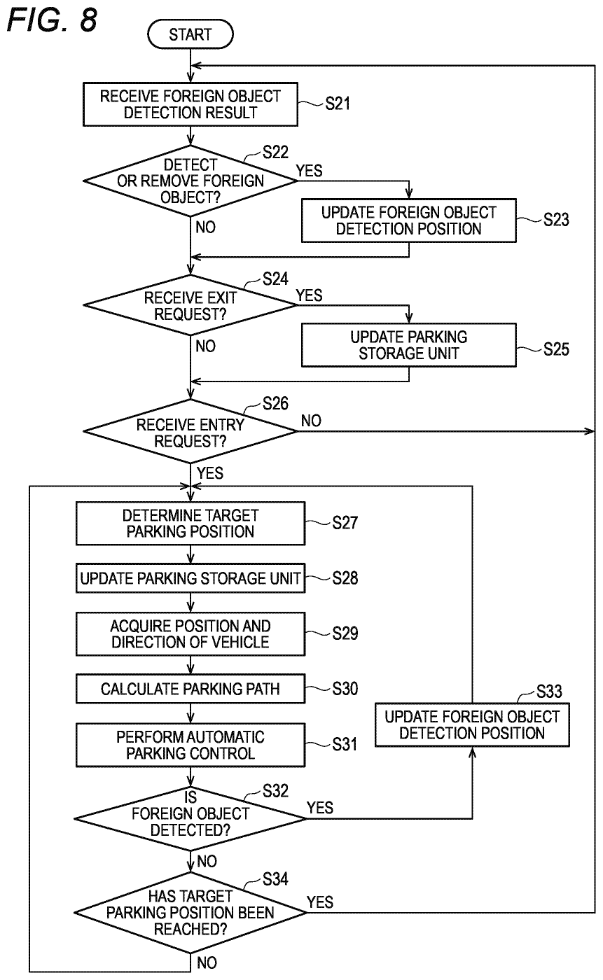

Next, an operation of the parking assist apparatus of the present embodiment will be described. FIG. 8 is a flowchart for illustrating the operation of the third embodiment.

In step S21 of FIG. 8, the control unit 51 of the management server 50 receives a foreign object detection result. In steps S22, S24, and S26, the control unit 51 performs reception determination regarding detection or removal of the foreign object, reception determination of the exit request, and reception determination of the entry request, respectively. The parking assist apparatus 10 and the power supply device 30 sequentially detect a metal-containing foreign object on the power supply coil 4 and in the vicinity thereof, and transmit information on detection of the foreign object or removal of the foreign object to the management server 50. When receiving the information on the detection or the removal of the foreign object in the communication unit 52 (step S22), the management server 50 updates the foreign object detection position storage unit 54 based on the received information in step S23 (step S23). The foreign object detection processing may be executed in predetermined periods in consideration of time passage of a state of presence or absence of a foreign object in the parking space, such as abandonment or leaving of the foreign object, removal of the foreign object, movement of the foreign object due to wind or other external forces, and the like, and the foreign object detection result may be updated. Further, when the foreign object is detected and wireless charging of a corresponding parking region is disabled, a foreign object detection state may be temporarily released after a predetermined time has elapsed, and the foreign object detection processing may be performed again to update the foreign object detection result in accordance with presence or absence of detection.

When the entry and exit request reception unit 55 receives the exit request in step S24, the control unit 51 updates the information of the parking storage unit 53 regarding the parking space P where a vehicle corresponding to the exit request is parked (step S25).

When the entry and exit request reception unit 55 receives the entry request in step S26, the control unit 51 controls the parking space determination unit 56 to determine a target parking position (step S27). Next, the control unit 51 updates the information in the parking storage unit 53 with the information of the vehicle corresponding to the entry request and the target parking position (step S28).

The control unit 51 acquires, via the communication unit 52, a position and a direction of the vehicle that has made the entry request (step S29). The parking path calculation unit 57 calculates a parking path based on a deviation between the position and the direction of the vehicle and the target parking position (step S30). The parking path calculation unit 57 transmits information of the calculated parking path to the parking assist apparatus 10 of the corresponding vehicle 1 via the communication unit 52. Thereafter, automatic parking control for guiding the vehicle 1 to the target parking position is performed while performing communication between the parking path calculation unit 57 and the parking assist apparatus 10 (step S31).

In the present embodiment, the control unit 51 determines whether the parking assist apparatus 10 or the power supply device 30 corresponding to the target parking position has detected the foreign object (step S32). When the metal-containing foreign object does not enter the power supply coil 4 or a vicinity thereof, it is determined in step S34 whether the target parking position has been reached. When the target parking position has not been reached, the processing returns to step S27. When the target parking position has been reached, the processing returns to step S21.

Now, when the foreign object information indicating that the foreign object is detected is transmitted from the corresponding parking assist apparatus 10 or the corresponding power supply device 30 before the vehicle 1 reaches the target parking position, the control unit 51 shifts the processing from step S32 to step S33, updates contents of the foreign object detection position storage unit 54, and returns the processing to step S27 to cause the parking position determination unit 22 to determine a new target parking position.

Thereafter, the processings of steps S27 to S34 are repeated. Finally, the vehicle 1 is parked in the parking space P where no metal-containing foreign object is detected.

When the foreign object detection position is updated in steps S23 and S33, the control unit 51 may display information on the update on the display device 58. Further, the control unit 51 may notify the administrator or the like of information on the foreign object detection. Further, for the parking space P where the foreign object is detected, the control unit 51 causes the display device 38 and the lamp 38a of the power supply device 30 to execute a warning indicating that the wireless charging cannot be performed due to the presence of the foreign object.

As described above, in the present embodiment, when a vehicle is parked in a parking space where the wireless charging can be performed by the automatic driving control, in a case where it is indicated that the metal-containing foreign object is present in the predetermined region including the wireless power supply unit in the parking region, for example, on the power supply coil or in the vicinity thereof, the management server guides the parked vehicle to a parking space other than the parking space. Accordingly, even in the auto valet parking, it is possible to automatically supply power while securing safety.

### Fourth Embodiment

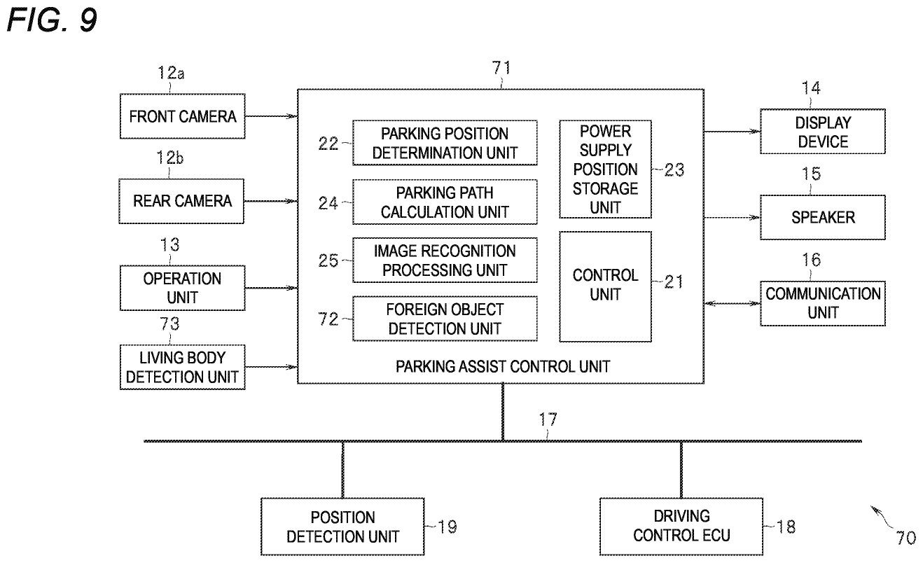

FIG. 9 is a block diagram showing an example of a configuration of a parking assist apparatus 70 according to a fourth embodiment. In FIG. 9, the same components as those of FIG. 1 are denoted by the same reference numerals, and the description thereof will be omitted.

The fourth embodiment corresponds to the first embodiment, and is an example of a case where an organism is present as a foreign object in a predetermined region including a wireless power supply unit in a parking region, for example, on a power supply coil serving as the wireless power supply unit or in the vicinity thereof.

The parking assist apparatus 70 is different from the parking assist apparatus 10 of FIG. 1 in that the parking assist apparatus 70 includes a parking assist control unit 71 that adopts a foreign object detection unit 72 instead of the foreign object detection unit 26, and includes a living body detection unit 73 serving as a detection device.

The foreign object detection unit 72 detects whether a foreign object that is an organism is present in the predetermined region (on the power supply coil 4 and in the vicinity thereof) including the wireless power supply unit in the parking region in accordance with an image recognition result of the image recognition processing unit 25. The foreign object detection unit 72 may determine whether the recognized foreign object is an organism in accordance with a shape, a color, and the like of the foreign object based on the image recognition result of the image recognition processing unit 25, and may estimate that an object having motion is an organism.

The living body detection unit 73 can detect whether an organism is present in the predetermined region including the wireless power supply unit in the parking region. For example, the living body detection unit 73 may be configured with a living body sensor, an infrared sensor, or the like. Further, the living body detection unit 73 may be configured with a pyroelectric sensor, a Doppler sensor, or the like to detect a moving organism on the power supply coil 4 and in the vicinity thereof.

The foreign object detection unit 72 may determine that the organism is positioned in the predetermined region including the wireless power supply unit in the parking region based on a detection result of the living body detection unit 73.

In the example of FIG. 9, it is determined whether the organism is positioned on the power supply coil 4 and in the vicinity thereof by image analysis and living body detection, but the organism may be detected by only one of the image analysis and the living body detection, and in this case, the other can be omitted as a configuration for foreign object detection.

In the embodiment configured as described above, the same operation as in the flowchart of FIG. 3 is performed. In step S6 of FIG. 3, it is determined whether a foreign object, which is an organism, is detected instead of a metal-containing foreign object. That is, in step S6, the control unit 21 determines whether the organism is detected by the foreign object detection unit 72 on the power supply coil 4 or in the vicinity thereof.

Other actions are the same as those of the first embodiment.

As described above, in the present embodiment, when the vehicle is parked in a parking space where wireless charging can be performed by the automatic driving control, it is detected whether the organism is present in the predetermined region including the wireless power supply unit in the parking region. Then, parking assist by the automatic driving control is controlled in accordance with a detection result of the organism. Accordingly, it is possible to execute an automatic power supply and the parking assist while securing safety.

### Fifth Embodiment

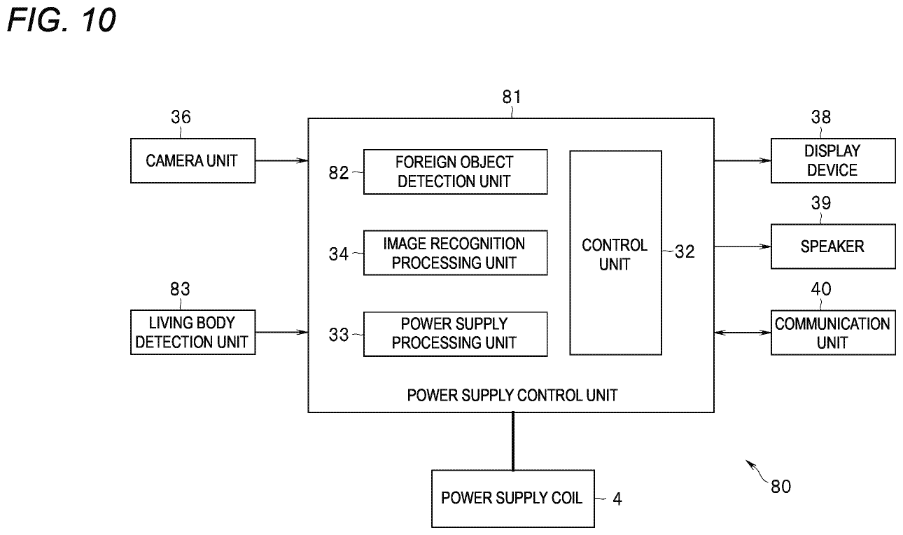

FIG. 10 is a block diagram showing an example of a configuration of a power supply device 80 according to a fifth embodiment. In FIG. 10, the same components as those of FIG. 4 are denoted by the same reference numerals, and the description thereof will be omitted.

The fifth embodiment corresponds to the second embodiment, and is an example of a case where an organism is present as a foreign object in a predetermined region including a wireless power supply unit in a parking region, for example, on a power supply coil serving as the wireless power supply unit or in the vicinity thereof.

The power supply device 80 is different from the power supply device 30 of FIG. 4 in that the power supply device 80 includes a power supply control unit 81 that adopts a foreign object detection unit 82 instead of the foreign object detection unit 35, and includes a living body detection unit 83 serving as a detection device instead of the metal detector 37.

The foreign object detection unit 82 detects whether a foreign object that is an organism is present in the predetermined region (on the power supply coil 4 and in the vicinity thereof) including the wireless power supply unit in the parking region in accordance with an image recognition result of the image recognition processing unit 34. The foreign object detection unit 82 may determine whether the recognized foreign object is an organism in accordance with a shape, a color, and the like of the foreign object based on the image recognition result of the image recognition processing unit 84, and may estimate that an object having motion is an organism.

The living body detection unit 83 can detect whether an organism is present in the predetermined region including the wireless power supply unit in the parking region. For example, the living body detection unit 83 may be configured with a living body sensor, an infrared sensor, or the like. Further, the living body detection unit 83 may be configured with a pyroelectric sensor, a Doppler sensor, or the like to detect a moving organism on the power supply coil 4 and in the vicinity thereof.

The foreign object detection unit 82 may determine that the organism is positioned in the predetermined region including the wireless power supply unit in the parking region based on a detection result of the living body detection unit 83.

In the example of FIG. 10, it is determined whether the organism is positioned on the power supply coil 4 or in the vicinity thereof by image analysis and living body detection, but the organism may be detected by only one of the image analysis and the living body detection, and in this case, the other can be omitted as a configuration for foreign object detection.

In the embodiment configured as described above, the same operation as in the flowchart of FIG. 6 is performed. In step S12 of FIG. 6, it is determined whether a foreign object, which is an organism, is detected instead of a metal-containing foreign object. That is, in step S12, the control unit 32 determines whether the organism is detected by the foreign object detection unit 82 on the power supply coil 4 and in the vicinity thereof.

Other actions are the same as those of the second embodiment.

As described above, in the present embodiment, when the vehicle is parked in a parking space where wireless charging can be performed by the automatic driving control, the power supply device detects whether the organism is present in the predetermined region including the wireless power supply unit in the parking region. Then, permission or prohibition of a power supply of the wireless charging is controlled in accordance with a detection result of the organism. Further, the power supply device transmits the foreign object information to the vehicle and stops the automatic parking control. Further, the power supply device presents to the user whether the wireless charging can be performed. Accordingly, it is possible to execute an automatic power supply and the parking assist while securing safety.

In the above-described third embodiment, an example has been described in which control is performed on a metal-containing object serving as the foreign object in the parking assist system including the management server, but it is apparent that the third embodiment may be applied to the fourth embodiment or the fifth embodiment to perform control by detecting only the organism or both the organism and the metal-containing object as the foreign object.

Also in the above-described first, second, fourth, and fifth embodiments, it is apparent that control may be performed on both the organism and the metal-containing object as foreign objects.

### Sixth Embodiment

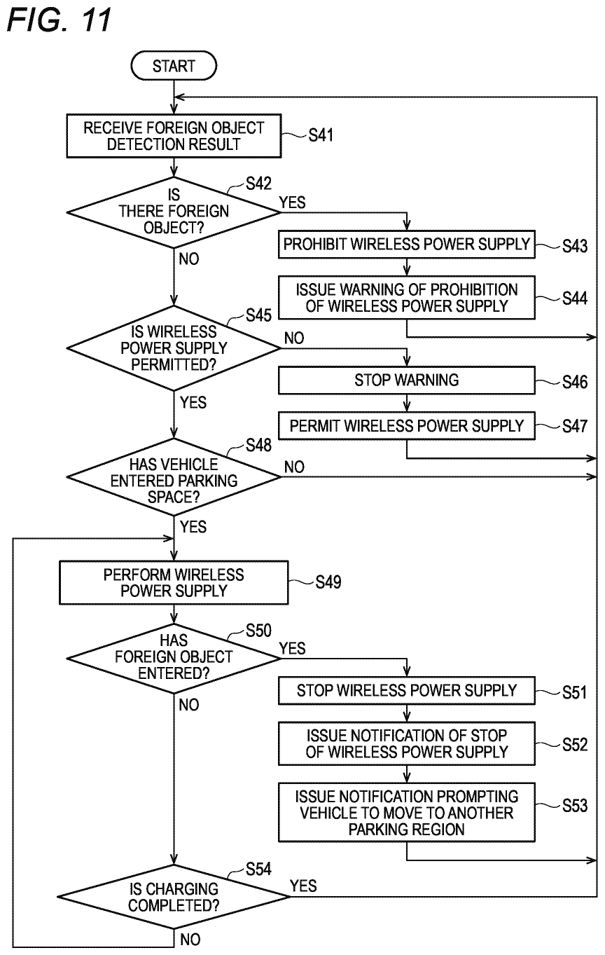

FIG. 11 is a flowchart for illustrating an operation of a sixth embodiment. Hardware configuration of the present embodiment is the same as that of FIG. 4 or FIG. 10.

The sixth embodiment corresponds to the second or fifth embodiment, and is an example of a case where a foreign object enters a power supply coil or a vicinity thereof during wireless charging.

In step S41, the control unit 32 receives a detection result of whether a metal-containing foreign object or an organism is present on the power supply coil 4 or in the vicinity thereof by the foreign object detection unit 35 or 82. The control unit 32 may receive the detection result of the foreign object from the parking assist apparatus 10 or 70.

In step S42, the control unit 32 determines whether the foreign object is present on the power supply coil 4 or in the vicinity thereof based on whether the foreign object information is acquired. When the foreign object is present, the control unit 32 controls the power supply processing unit 33 to prohibit a power supply of wireless charging (step S43), controls the display device 38 and the lamp 38a to warn the prohibition of the power supply of the wireless charging due to the foreign object (step S44), and returns the processing to step S41. The control unit 32 may transmit notification information indicating that the wireless charging is prohibited in the parking space P to the vehicle 1 or the management server 50 of FIG. 7 via the communication unit 40.

When determining in step S42 that no foreign object is present on the power supply coil 4 and in the vicinity thereof, the control unit 32 determines in next step S45 whether the power supply of the wireless charging is permitted. When the foreign object has been detected before, the power supply of the wireless charging is prohibited, and no foreign object is currently present (step S45: NO), the control unit 32 stops the warning of the foreign object detection (step S46), permits the power supply of the wireless charging (step S47), and returns the processing to step S41.

When determining in step S45 that the power supply of the wireless charging is permitted, the control unit 32 determines in next step S48 whether the vehicle has entered a parking space. When the vehicle has not entered the parking space, the control unit 32 returns the processing to step S41. As described above, steps S41 to S48 are in a standby state until the entry of the vehicle into the parking space is completed.

When the vehicle enters the parking space, the control unit 32 shifts the processing from step S48 to step S49 to perform the power supply of the wireless charging. Accordingly, a battery (not shown) in the vehicle is charged. When the foreign object is present on the power supply coil 4 or in the vicinity thereof at a time point at which the vehicle enters the parking space, the power supply of the wireless charging is prohibited in step S43, and the power supply of the wireless charging is not performed even when the vehicle enters the parking space. In this case, the control unit 32 may transmit a foreign object detection result to the vehicle 1 or the management server 50 to guide the vehicle 1 to another parking space.

The control unit 32 determines whether the foreign object has entered in step S50 during the power supply of the wireless charging. When no foreign object enters the power supply coil 4 and the vicinity thereof, the control unit 32 determines whether charging is completed in step S54. When the charging is not completed, the control unit 32 returns the processing to step S49. When the charging is completed, the control unit 32 returns the processing to step S41.

When the foreign object enters the power supply coil 4 or the vicinity thereof during the power supply of the wireless charging, the control unit 32 detects presence of the foreign object or receives the foreign object information in step S50, and stops the power supply of the wireless charging in step S51. Next, the control unit 32 transmits a notification indicating that the power supply of the wireless charging is stopped to the display device 38, the lamp 38a, and the like, and notifies the stop of the wireless charging by a display or the like (step S52). Subsequently, the control unit 32 transmits a notification for prompting the vehicle to move to another parking region to the vehicle 1 or the management server 50, and guides the vehicle 1 to move by designating a parking space at another target parking position (step S53). Accordingly, the user or the management server re-designates another target parking position, and causes the automatic parking control of the vehicle 1 to a movement destination to be performed. Then, the control unit 32 returns the processing to step S41.

When the vehicle is in an entry state and the foreign object is removed, the power supply of the wireless charging is restarted in step S49.

As described above, in the present embodiment, when the vehicle is parked in a parking space where the wireless charging can be performed by the automatic driving control, the power supply device detects whether the foreign object is present on the power supply coil or in the vicinity thereof, and controls the permission or the prohibition of the power supply of the wireless charging. When the foreign object enters the power supply coil or the vicinity thereof during the power supply of the wireless charging, the power supply of the wireless charging is stopped, and safety is secured. Further, by moving the vehicle by performing the automatic parking control to another parking region, it is possible to appropriately complete charging of the vehicle in accordance with presence or absence of the foreign object in the charging system of the automatic control in which the automatic parking control and the wireless charging by the automatic power supply are combined. Other effects are the same as those of the above-described embodiments.

As described above, the parking assist apparatus of the present embodiment performs the automatic parking control by the parking assist control unit 11 so as to automatically park the vehicle 1 in the parking space P serving as the parking region of the vehicle 1 capable of the wireless charging. The parking region is provided with the power supply coil 4 serving as the wireless power supply unit that supplies electric power to the vehicle 1 in a wireless manner. The parking assist apparatus acquires the foreign object information indicating that the foreign object 6 is present in the predetermined region including the wireless power supply unit in the parking region by the foreign object detection unit 26 serving as the foreign object information acquisition unit and the communication unit 16. The parking assist control unit 11 stops the automatic parking control when the foreign object information is acquired. Accordingly, for example, when the foreign object is present on the power supply coil 4 or in the vicinity thereof, since the automatic parking control is stopped, the power supply of the wireless charging is not performed, and the automatic power supply of the wireless charging and the parking assist can be executed while securing safety. Further, it is possible to prevent the automatic parking control from being unnecessarily performed, and to guide the vehicle to another parking region where no foreign object is present.

In the parking assist apparatus of the present embodiment, the foreign object 6 is a metal-containing object. Accordingly, when there is the metal-containing foreign object, fire or the like due to the power supply of the wireless charging is prevented. Further, in the parking assist apparatus of the present embodiment, the foreign object 6 is the organism. Accordingly, damage to the organism due to the power supply of the wireless charging is prevented.

In the parking assist apparatus of the present embodiment, the foreign object information acquisition unit includes the foreign object detection unit 26 or 72 that detects the foreign object based on detection information in the vicinity of the vehicle by the detection device such as the rear camera 12b and the living body detection unit 73 provided on the vehicle 1. Accordingly, when the foreign object is detected by the vehicle 1 and the foreign object information is acquired, the automatic parking control can be stopped, and the automatic parking control and the wireless charging by the automatic power supply can be implemented while securing safety.

In the parking assist apparatus of the present embodiment, the foreign object information acquisition unit includes the foreign object detection unit 35 provided in the power supply device 30 including the wireless power supply unit, and the communication unit 16 that receives the information of the foreign object detected by the metal detector 37. Accordingly, when the foreign object is detected on the wireless power supply unit or in the vicinity thereof and foreign object information thereof is received, the automatic parking control can be stopped, and the automatic parking control and the wireless charging by the automatic power supply can be implemented while securing safety. Further, by detecting and notifying the foreign object on the power supply side, it is possible to recognize in advance whether the wireless charging can be performed when the user designates the target parking position or the like in a case where the foreign object is present.

In the parking assist apparatus of the present embodiment, when the foreign object information is acquired, the parking assist control unit 11 performs the automatic parking control for guiding the vehicle 1 to another parking region. Accordingly, the vehicle can be parked in another parking region where no foreign object is present, and the wireless charging can be executed.

In the parking assist apparatus of the present embodiment, when the foreign object information is acquired, the parking assist control unit 11 excludes the parking region where the foreign object is detected from a parking target. Accordingly, it is possible not to perform the automatic parking control to the parking region where the foreign object is detected, and it is possible to park the vehicle in the parking region where the wireless charging can be appropriately performed, and to execute the wireless charging.

The parking assist apparatus of the present embodiment further includes the display device 14 or the like serving as the notification unit that issues the notification indicating that the wireless charging cannot be performed in the parking region where the foreign object is detected when the foreign object information is acquired. Accordingly, the user, the administrator, or the like can easily recognize that the wireless charging cannot be performed in the corresponding parking region.

In the parking assist apparatus of the present embodiment, the notification unit includes at least one of the display device 14 that displays availability information of the wireless charging, the lamp 38a serving as the lighting device that lights and displays an availability state of the wireless charging, the speaker 15 serving as the sound output device that outputs the availability information of the wireless charging by a sound, and the communication unit 16 or 40 that notifies other devices such as the management server and the power supply device. Accordingly, the user, the administrator, or the like can easily recognize a presence state of the foreign object in the parking region, availability of the wireless charging, and the like by a warning display or a state display of the display device, lighting of the lighting device, a sound output of the sound output device, and the like.

In the parking assist apparatus of the present embodiment, the notification unit includes the lamp 38a serving as the lighting device that lights and displays the availability state of the wireless charging, and the lighting device makes a lighting color or a lighting mode different in accordance with a detection state of the foreign object and an availability state of the parking region. Accordingly, the user, the administrator, or the like can easily recognize the presence state of the foreign object in the parking region, the availability of the wireless charging, the availability state of the parking region, and the like by the lighting color or the lighting mode of the lighting device.

The parking assist apparatus of the present embodiment includes the control unit 32 serving as the power supply instruction unit that stops a power supply by the wireless power supply unit when the foreign object information is acquired. Accordingly, for example, when the foreign object is present on the power supply coil 4 or in the vicinity thereof, since the power supply of the wireless charging is stopped, the automatic power supply of the wireless charging and the parking assist can be executed while securing safety.

In the parking assist apparatus of the present embodiment, the power supply instruction unit stops a power supply by the wireless power supply unit when presence of the foreign object is detected during a power supply to the vehicle. Accordingly, when the foreign object is detected during the power supply of the wireless charging, the power supply is stopped, so that the wireless charging can be performed while securing safety.

The parking assist apparatus of the present embodiment further includes the management server 50 serving as the management device that manages the automatic parking control of the vehicle and the power supply of the wireless charging in the parking region, and the management device designates another parking region for performing the automatic parking control on the vehicle 1 when the foreign object information is acquired in the parking region. Accordingly, it is possible to guide the vehicle to another parking region where no foreign object is present by performing the automatic parking control, and to appropriately execute the automatic power supply of the wireless charging and the parking assist.

In the parking assist apparatus of the present embodiment, when the foreign object information is acquired in the parking region, the management device excludes the corresponding parking region from the parking target. Accordingly, it is possible to exclude the parking region where the foreign object is present from the parking target, to prevent the vehicle 1 from being guided to the parking region where the wireless charging cannot be performed, and to perform the automatic parking control to an appropriate parking region where the wireless charging can be performed.

Although various embodiments have been described above with reference to the drawings, it is needless to say that the present disclosure is not limited to such examples. It is apparent that those skilled in the art can conceive of various modifications, amendments, substitutions, additions, deletions, and equivalents within the scope described in the claims, and it is understood that such modifications, amendments, substitutions, additions, deletions, and equivalents naturally fall within the technical scope of the invention. Components in the above-described embodiments may be optionally combined within a range not departing from the spirit of the invention.

The present application is based on a Japanese Patent Application (Japanese Patent Application No. 2019-112949) filed on Jun. 18, 2019, the contents of which are incorporated by reference in the present application.

The present disclosure is useful as a parking assist apparatus and a parking assist method that can implement a more suitable improvement in parking assist for a parking space of a vehicle capable of wireless charging.

1. A parking assist apparatus configured to perform parking control so as to park a vehicle in a parking region provided with a wireless power transmitter configured to supply electric power, in a non-contact manner, to the vehicle capable of wireless charging, the parking assist apparatus comprising:
a processor; and
a memory having instructions that, when executed by the processor, cause the parking assist apparatus to perform operations comprising:
acquiring foreign object information indicating that a foreign object is present in a predetermined region comprising the wireless power transmitter in the parking region; and
stopping the parking control in a case in which the foreign object information is acquired.

2. The parking assist apparatus according to claim 1,
wherein the foreign object is a metal-containing object.

3. The parking assist apparatus according to claim 1,
wherein the foreign object is an organism.

4. The parking assist apparatus according to claim 1,
wherein the parking control comprises automatically parking the vehicle.

5. The parking assist apparatus according to claim 1,
wherein the parking control comprises:
setting a target parking position at an optimum charging position where a power reception coil and a power supply coil face each other; and
controlling the vehicle to be parked at the target parking position.

6. The parking assist apparatus according to claim 1,
wherein the acquiring the foreign object information comprises:
detecting the foreign object based on detection information in a vicinity of the vehicle obtained by a detection device provided in the vehicle.

7. The parking assist apparatus according to claim 6,
wherein the detection device comprises a camera, and
wherein the detecting the foreign object comprises:
performing image recognition based on image information from the camera; and
determining whether the foreign object is present in the predetermined region.

8. The parking assist apparatus according to claim 6,
wherein the detection device comprises a living body detector, and
wherein the detecting the foreign object comprises determining whether the foreign object is present in the predetermined region based on a detection result of the living body detector.

9. The parking assist apparatus according to claim 1, further comprising:
a communication device,
wherein the acquiring the foreign object information comprises receiving information of a foreign object detected by a foreign object detector provided in the wireless power transmitter via the communication device.

10. The parking assist apparatus according to claim 1,
wherein the operations further comprise performing the parking control for guiding the vehicle to another parking region in a case in which the foreign object information is acquired.

11. The parking assist apparatus according to claim 1,
wherein the operations further comprise excluding a parking region where the foreign object is detected from a parking target in a case in which the foreign object information is acquired.

12. The parking assist apparatus according to claim 1, further comprising:
a notification device,
wherein the operations further comprise causing the notification device to issue a notification in a case in which the foreign object information is acquired, the notification indicating that wireless charging is unavailable in a parking region where the foreign object is detected.

13. The parking assist apparatus according to claim 12,
wherein the notification device comprises at least one of a display device configured to display availability information of wireless charging, a lighting device configured to light and display an availability state of wireless charging, a sound output device configured to output availability information of wireless charging by a sound, and a communication device configured to notify another device.

14. The parking assist apparatus according to claim 12,
wherein the notification device comprises a lighting device, and
wherein the operations further comprise causing the lighting device to light and display an availability state of wireless charging so as to make a lighting color or a lighting mode different in accordance with a detection state of the foreign object and an availability state of the parking region.

15. The parking assist apparatus according to claim 1,
wherein the operations further comprise stopping a power supply by the wireless power transmitter in a case in which the foreign object information is acquired.

16. The parking assist apparatus according to claim 15,
wherein the stopping the power supply comprises stopping the power supply by the wireless power transmitter in a case in which presence of the foreign object is detected during the power supply to the vehicle.

17. The parking assist apparatus according to claim 1, further comprising:
a management device configured to manage the parking control of the vehicle and a power supply of wireless charging in the parking region,
wherein in a case in which the foreign object information is acquired in the parking region, the management device is configured to designate another parking region for performing the parking control on the vehicle.

18. The parking assist apparatus according to claim 17,
wherein in a case in which the foreign object information is acquired in the parking region, the management device excludes the corresponding parking region from a parking target.

19. A parking assist method for performing parking control so as to park a vehicle in a parking region provided with a wireless power transmitter configured to supply electric power, in a non-contact manner, to the vehicle capable of wireless charging, the parking assist method comprising:
acquiring foreign object information indicating that a foreign object is present in a predetermined region comprising the wireless power transmitter in the parking region; and
stopping the parking control in a case in which the foreign object information is acquired.

20. A non-transitory computer-readable medium storing a program that, when executed by a processor, cause a computer to perform operations for performing parking control so as to park a vehicle in a parking region provided with a wireless power transmitter configured to supply electric power, in a non-contact manner, to the vehicle capable of wireless charging, the operations comprising:
acquiring foreign object information indicating that a foreign object is present in a predetermined region comprising the wireless power transmitter in the parking region; and
stopping the parking control in a case in which the foreign object information is acquired.
